(19) United States
(12) Patent Application Publication
(10) Pub. No.: US 2008/0274247 A1
(43) Pub. Date: Nov. 6, 2008

(54) Methods for Roasting Oil Seed, and Roasted Oil Seed Products

(76) Inventor: Cecil Werner, Saskatchewan (CA)

Correspondence Address: KIRBY EADES GALE BAKER, BOX 3432, STATION D, OTTAWA, ON, K1P 6N9, CA

(21) Appl. No.: 11/576,405

(22) PCT Filed: Sep. 21, 2005
(86) PCT No.: PCT/CA05/01431

§ 371 Date: Feb. 12, 2008

Related U.S. Application Data
(60) Provisional application No. 60/614,458, filed on Oct. 1, 2004.

(51) Int. Cl. A23L 1/36; A23L 3/16

(52) U.S. Cl. 426/466

(57) ABSTRACT

Methods for the production of roasted oil seed such as flax seed are disclosed, as well as products derived therefrom. The methods give rise to roasted products having desirable characteristics including, but not limited to, improved flowability, taste, aesthetic qualities, and sterility Moreover, the roasted products can be more easily broken up by chewing or processing, for example to produce a corresponding flour.

### FIELD OF THE INVENTION

The invention relates to methods for the preparation of grain crops for human or animal consumption. More particularly, the invention relates to methods for the roasting of oil seed such as flax.

### BACKGROUND

The consumption of flax seed by humans and other animals may provide several benefits for improving and maintaining general health. Flax seed is rich in dietary fibre, protein, and alpha-linolenic acid: an essential Omega-3 fatty acid. Indeed, more than 70% of the lipid content of flax seed may encompass polyunsaturated fats, with a high ratio of alpha-linolenic acid (an Omega-3 fatty acid) to linolenic acid (an Omega-6 fatty acid). The potential health benefits of increasing dietary intake of Omega-3 fatty acids are well documented, and potentially include prophylaxis of disorders such as heart disease and cancer. Flax seed also provides a supply of lignans, which may exhibit useful properties in the prophylaxis of cancer. Numerous other potential health benefits are also known.

To humans and other animals the taste of raw, untreated flax seed can be unpleasant, and the consistency of the flax seed can make it rather difficult to chew, swallow or digest. Typically, at least for human consumption, raw, untreated flax seed may be ground to a powdery consistency via a grinder (e.g. a coffee grinder or industrial scale grinder), and the taste of the raw flax seed masked as desired. Raw, untreated flax seed is also rather difficult to handle. Once the seed has been broken, and the inner fleshy portions of the seed exposed to air, the flax seed can exhibit poor stability and begin to degrade and decompose fairly quickly making it unsuitable for human consumption. Some of the challenges regarding the handling and consumption of raw flax seed can be overcome by roasting or otherwise heating the flax seed. In this way, the flax seed can become more palatable, more stable, and easier to handle. Various systems have been generated for the roasting or heating of particulate matter. However, many of these systems are designed specifically for the roasting of coffee beans. In one example, European Patent Application 055,462 published Jul. 7, 1982 discloses a method and device for roasting coffee beans by suspending and revolving the beans in a column of air having a controlled temperature and flow. In another example, Canadian Patent 1,201,006 issued Feb. 26, 1986 discloses an apparatus for roasting small quantities of coffee including a roasting chamber and an inlet orifice extending into the chamber for streaming hot roasting gas into the chamber, thereby generating a toroidal circulation of the coffee beans for even roasting thereof.

Other systems and methods have been developed for roasting and conditioning of oilseed which often take advantage of fluidized bed technology. For example, U.S. Pat. No. 4,109,394 issued Aug. 29, 1987 discloses a system for treatment of particulate material including a conveyor for transporting particulate material through a treatment zone, a gas flow system for placing the particles on the conveyor in a fluidized condition as they pass through the treatment zone, and means along the side of the treatment zone for projecting a gaseous stream inwardly along the transport surface of the conveyor to provide a boundary sheath gas flow along the edge of the treatment zone.

In another example, U.S. Pat. No. 4,419,834 issued Dec. 13, 1983 discloses a fluidized bed apparatus comprising a foraminous support such as a perforate place, a screen, or the like, gas supply means to supply a fluidizing gas beneath the support and a plurality of moveable flights above the support adapted to sweep the fluidized material along the support. The apparatus is especially adapted for such heat treating processes as drying, toasting, roasting, and freezing of particulate food materials.

Other methods of the prior art focus upon dehulling of oilseeds. For example, Ikebudu et al. (2000) “Grain conditioning for dehulling of canola”, Canadian Agricultural Engineering 42(1), 4.1 to 4.13, discloses a comparison of various methods for treating canola for the purposes of dehulling. Optimal dehulling was achieved by moistening the grain to about 15% moisture content for 10 minutes followed by heating at 70-75° C. for 5 minutes. Similar results were achieved by heating the grain at 120° C. for 5 minutes without moistening.

In another example, Canadian Patent 2,167,951 issued Apr. 30, 2002, discloses a dry process for dehulling flax seed. The method comprises three principle steps: drying the flax seed, breaking the flax seed (e.g. by milling), and fractionation by air classification. The preferred drying method involves fluid bed drying employing heat.

Such methods for dehulling are especially useful where it is desirable to separate flax seed into a hull fraction and a kernel fraction. Typically, lignans and flax seed gum may be extracted sequentially from the hull fraction, whereas protein and lipid fractions may be extracted from the kernel fraction by further processing. Under many circumstances, however, it is desirable to consume whole flax seed without the need for dehulling. As previously discussed raw, untreated flax seed is difficult to handle and consume unless it is roasted. However, it should be noted that roasting of whole flax seed for consumption presents some additional challenges. It is widely known that flax seed is sensitive to roasting processes. For example, flax seed has a fairly fine grain, and the components of flax seed, including Omega-3 fatty acids, are highly susceptible to degradation upon exposure to roasting conditions sufficient to render the flax seed palatable. Often, such roasting processes generate a flax seed product that is pleasing to the consumer, but which has significantly reduced nutritional value.

There remains a continuing need to develop methods and systems for roasting oil seed such as flax seed, which generate a roasted oil seed or flax seed product that is tasty, easily consumed, stable, and yet which substantially retains the nutritional value of the untreated grain.

### SUMMARY

It is one object of the exemplary embodiments to provide a method for roasting oil seed such as flax seed suitable to generate a roasted oil seed or flax seed product.

Certain exemplary embodiments provide for a method for roasting oil seed, the method comprising the steps of:
(a) heating the oil seed at a temperature of from about 130° C. to about 205° C. in less than about two minutes to produce heated oil seed;
(b) maintaining the heated oil seed at a sufficient temperature and for a sufficient period to produce roasted oil seed; and
(c) cooling the roasted oil seed.

Certain exemplary embodiments provide for roasted oil seed generated by the method of the exemplary embodiments.

Certain exemplary embodiments provide for a food product for human or animal consumption comprising the roasted oil seed of the exemplary embodiments.

Certain exemplary embodiments provide for a beverage product for human or animal consumption comprising the roasted oil seed product of the exemplary embodiments.

### BRIEF DESCRIPTION OF THE DRAWINGS

FIG. 1 illustrates a flow chart of an exemplary method;

FIG. 2 illustrates a flow chart of another exemplary method.

### DETAILED DESCRIPTION

Oil seeds and oil seed products include nutritional components that form an important or essential part of a healthy diet. For example, flax seed provides particular benefits as previously discussed. Optimal or near optimal techniques have been developed for facile and rapid processing of whole flax seed for consumption by humans or other animals. The methods that have been developed may be applied to small quantities or batches of oil seed such as flax seed, or alternatively may be applied on an industrial scale including continuous industrial operations.

The methods and examples described herein refer to flax seed. However, the methods may be carried out utilizing any suitable oil seed. Exemplary oil seeds encompass, among others, those of the Linaceae family as well as additional suitable seeds as would be determined by one of skill in the art.

For the purpose of this specification and the examples therein, the term flax seed encompasses any seed member of the Linaceae family including, for example, L. usitatissimum.

A method of processing oil seed is provided that is simple and effective in generating a roasted oil seed product that exhibits at least two, but as many as all, of the following characteristics in combination:
excellent nutritional content, including a substantially preserved Omega-3 fatty acid content;
elimination or substantial elimination of enzymes that cause the release of cyanide glycosides;
excellent aesthetic appeal;
excellent handling properties;
amenable to grinding, milling, slicing or crushing for processing into foodstuffs;
high stability; and
pleasing flavour.

Exemplary embodiments provide for methods that generate a roasted flax seed product that is palatable, easily consumed, and yet retains most of the nutritional value (particularly, for example, with regard to Omega-3 fatty acid content—see Examples). It has been determined that the methods provided are simultaneously effective in reducing or substantially eliminating the presence of enzymes in the flax seed that cause the release of toxic cyanide glycosides in the body. Typically, in raw flax seed cyanide glycosides may be present in concentrations of from about 130 ppm to in excess of about 300 ppm. However, the methods provided by certain exemplary embodiments, generate a roasted flax seed product comprising less than about 1 ppm of cyanide glycosides (see Examples). In addition, the exemplary methods may satisfy further subjective requirements of the discerning consumer including, for example, to improve the taste and appearance of flax seed.

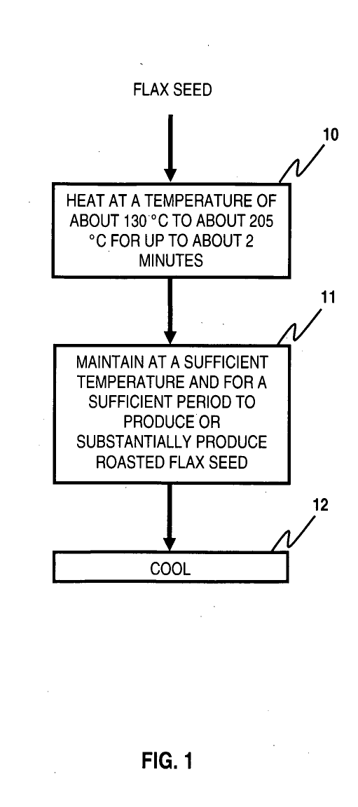

Defined heating, maintaining and cooling steps can generate a roasted flax seed product that exhibits some or all of the desirable properties discussed above. For example, exemplary embodiments encompass methods that will be described with reference to FIG. 1. In the first step shown in FIG. 1, flax seed is initially exposed to a temperature of from about 130° C. to about 205° C. for up to about 2 minutes (10). This initial heating step can, if desired, cause the temperature of the flax seed to rise uniformly and very rapidly. This can be achieved, at least in exemplary embodiments by allowing heated air to circulate around and intersperse between the flax seed, effectively to cause the flax seed to achieve a “suspended in air” state. In this way, the entire surface area of each flax seed will be substantially uniformly exposed to the heating temperatures.

Any heating system may be used to heat the flax seed to a desired temperature, providing this can be done fairly rapidly in accordance with the methods of the exemplary embodiments. For example, fluidized bed systems are particularly suited to achieve the heating conditions for flax seed that are desired in accordance with the exemplary embodiments. Any fluidized bed system may be suitable for use in accordance with the invention. Exemplary fluidized bed systems pertain to those produced by Wolverine Procter, including for example the fluidized bed apparatuses and systems produced under the trademark “Jetzone”. Such apparatuses are capable of generating high-velocity air jets from elongated jet-tubes. The air jets may be directed in, for example, a generally downward direction to deflect off a conveyor upon which is carried particulate matter comprising the flax seed. As the air jets pass though the particulate matter, and deflect from the conveyor, this helps to lift and tumble the particulate matter comprising the flax seed. In one exemplary embodiment, open spaces are present between the jet tubes forming a series of chambers within which the particulate matter can tumble and settle. For example, small debris and dust in the particulate matter can settle out in the chamber and processed air recirculated without affecting the jet-tubes. The conveyor may be, for example, a non-perforated conveyor.

A suitable jet-tube may be for example a tube, optionally a substantially cylindrical tube, that directs a stream of air, or other suitable non-toxic gas, optionally under elevated pressure, into particulate material to generate fluidized bed conditions in the material. The jet-rube may include, for example, the elements of a Jetzone™ fluidized bed system manufactured by Wolverine Proctor that direct streams of air onto a moving conveyor to generate fluidized bed conditions on the conveyor. The jet-tube however, is not limited to the elements of a Jetzone™ fluidized bed system.

In their broadest sense, the parameters for the heating step involve exposing the flax seed to a temperature of from about 130° C. to about 205° C. for up to about 2 minutes. This range of conditions is reasonably expected to produce desirable results in accordance with the teachings of the invention. Flax seed may be derived from different sub-species of flax seed crops, or from crops grown under different environmental conditions. The range of heating conditions (in terms of heating temperature and time of heat exposure) accounts in part for the variation observed in flax seed derived from different sources. For some forms of flax seed it may be desirable heat for a shorter period of time at a higher temperature (for example about 25 seconds at about 205° C.) whereas for other forms of flax seed it is desirable to heat the flax seed for a longer time period at a lower temperature (e.g. about 2 minutes at about 130° C.). In still further forms of flax seed, a longer exposure to high levels of heat may be desired, whereas in still further forms a shorter exposure to lower levels of heat may be desired. In any event, the methods of the invention encompass methods comprising an initial heating step wherein the step involves exposure to a fairly short “burst” of heat of less than about 2 minutes in length. This appears at least in part responsible for generating the desirable properties in the roasted flax seed product.

Subsequent to the heating step (10), the flax seed is maintained at a temperature and for a period suitable to produce roasted flax seed (11). The maintaining step (11) of flax seed encompasses retaining heated flax seed under any conditions or environments that permit the heated flax seed to become fully or at least substantially roasted over a suitable period of time. The step of maintaining may involve transfer of the heated flax seed from the heating step to a roasting chamber or tower that may be insulated or partially insulated to reduce the rate of heat loss therefrom. It should be noted that the step of maintaining may also be conducted within a heating apparatus used for the heating step. However, where the heating step is conducted using a fluidized bed apparatus or system, it may, at least in some embodiments, be impractical to conduct the step of maintaining without transferring the heated flax seed elsewhere, such as for example to a roasting chamber or tower. During the maintaining step the flax seed is retained at a suitable temperature for completing or at least substantially completing the roasting of the flax seed. The suitable temperature is elevated when compared to standard and/or common ambient temperatures. Moreover, the maintaining step may continue for an extended period of time, at least when compared to the heating step. Therefore, it is during the maintaining step that the flax seed becomes fully or at least substantially roasted. In certain exemplary embodiments, the maintaining step involves maintaining the heated flax seed in a roasting chamber or tower without the addition of further heat. In this way the flax seed may cool slightly during the maintaining period but the heated flax seed retains a sufficiently high temperature for a sufficient period of time to complete or substantially complete the roasting process. Without wishing to be bound by theory, it is considered likely that the exposure of the flax seed to a “burst” of thermal energy, followed by a passive maintaining step to complete the roasting process, may be responsible for achieving the desired combination of characteristics in the roasted flax seed product. The majority of the nutritional contents of the flax seed remain substantially intact during the roasting process (see examples), and yet the roasting process proceeds to a sufficient extent to achieve a sufficiently or substantially roasted product with desirable taste and aesthetic characteristics. However, the invention is not limited in this regard, and further encompasses exemplary embodiments that provide for methods that employ a maintaining step, wherein a quantity of thermal energy is added to the roasting chamber or column to retain the internal temperature of the chamber or tower within for example about 10° C. of a desired roasting temperature.

A suitable and exemplary roasting chamber or tower may be any confined space in which heated flax seed may be maintained for a period of time at a suitable temperature, thereby to complete or substantially complete the roasting of the flax seed. The chamber or tower may be optionally insulated or partially insulated thereby to control, regulate or limit the rate of heat dissipation or loss from the chamber or tower, and the heated flax seed contained therein.

The length of the maintaining period may vary according to the nature of the flax seed that is being processed. The maintaining step may last longer than about 30 minutes. Typically, the maintaining step may continue for a period of from about 2 to about 15 minutes or longer depending upon the flax seed and the maintaining temperature. For example, for most flax seed heated to a temperature of about 170° C. it has been determined that a maintaining period of about 9 minutes is optimal, for example in a roasting chamber or tower without the addition of thermal energy. The use of an insulated roasting chamber or tower that does not require input of additional thermal energy during the maintaining step pertains to an exemplary embodiment. Corresponding methods employing an insulated chamber or tower are more efficient, require less thermal energy for the roasting process, and further help to ensure that nutritious components of the flax seed (including Omega-3 fatty acids) are not destroyed by excessive thermal energy in the system.

In any event, the main purpose of the maintaining step is to allow the flax seed to continue to respond to the elevated temperature established by the heating step, for a time at least sufficient, or for example just sufficient, to substantially complete the roasting process.

Following the maintaining step (11), the next step in the method involves cooling (12). In its broadest sense, the step of cooling simply requires a reduction in the temperature of the flax seed from a temperature at which the roasting process continues to a lower temperature more suited for handling or packaging the roasted flax seed. For example, following the maintaining step the flax seed may simply be left to cool in the roasting chamber or tower or elsewhere. However, it should be noted that passive cooling of this kind can be somewhat protracted, particularly where the roasting chamber or tower is well insulated. For this reason, the roasted flax seed may be transferred out of the roasting chamber or tower to a different location better suited for cooling, for example having a lower ambient temperature, less efficient or no insulation, or better air circulation.

In other exemplary embodiments the roasted flax seed is actively cooled for example by way of a cooling system. In accordance with the discussion of the heating step (10) fluidized bed systems are one suitable means for cooling. These may include more traditional fluidized bed systems that are well known in the art, or may involve fluidized bed systems employing one or more jet-tubes each suitable for directing a jet of air in a direction to deflect off a conveyor, for example a non-perforated conveyor, such as the Jetzone fluidized bed system (Wolverine Procter). In this way, roasted flax seed on the conveyor can be lifted and temporarily suspended in high velocity streams of cooling air, thereby rapidly cooling the roasted flax seed and terminating any roasting that might still be taking place. Typically, when using such fluidized bed systems for cooling of particulate matter, heat transfer from the particulate matter is substantially rapid and uniform.

Other exemplary suitable cooling means include those involving a perforated conveyor. Roasted flax seed may be retained on a perforated conveyor, and cooling air (e.g. ambient air) may be drawn downwardly around the roasted flax seed and through the perforated conveyor, thereby transferring heat away from the flax seed. Minimal product degradation appears to occur with this type of cooling means. The perforated conveyor may take any form that allows air to pass therethrough, including an open mesh conveyor belt. One example of a suitable cooling means comprising an open mesh conveyor belt is a Through-Draft Belt Cooler™ produced by Wolverine Procter.

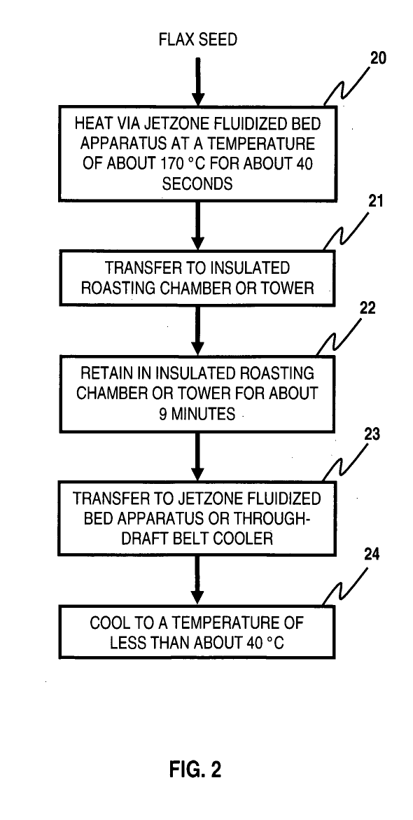

A further exemplary embodiment will now be described with reference to FIG. 2. This exemplary embodiment employs a Jetzone fluidized bed apparatus (or equivalents thereof) for conducting very rapid heating and cooling steps. Moreover, the maintaining step employs a well insulated roasting chamber that does not require the addition of thermal energy to retain the heated flax seed at a sufficient temperature for a time just sufficient to complete or substantially complete the roasting process. In the first step (20) the flax seed is very rapidly heated using a fluidized bed apparatus wherein the air jets exiting the jet-tubes comprise high velocity streams of air at about 170° C. The heating step continues for about 40 seconds, following which the heated flax seed is immediately transferred to a well insulated roasting chamber or tower (21). Subsequently, the heated flax seed is retained (22) in the well insulated chamber or tower for a period sufficient to produce roasted flax seed which usually corresponds to about 9 minutes (the precise time is predetermined by the rate of heat discharge from the chamber or tower). The roasted flax seed is then immediately transferred (23) to a cooling apparatus. This cooling apparatus may be in the form of a Jetzone fluidized bed apparatus (or equivalent thereof), which may be the same or different to the apparatus used for the heating step (20). Alternatively the roasted flax seed may be transferred to a cooling apparatus in the form of a Through-Draft Belt Cooler (23). In any event, the roasted flax seed is very rapidly cooled (24) using the cooling apparatus. The air passing around the roasted flax seed may have a temperature less than about 50° C. thereby rapidly transferring heat away from the flax seed and terminating the roasting process.

The methods of at least various exemplary embodiments, give rise to a flax seed product having a pleasant nutty like flavour that considered by some to be similar to roasted sesame seed. The whole roasted flax seeds are easy to break up by chewing and/or mechanical grinding and/or milling. For this reason, it is not always necessary to make flour from roasted flax seed in order to obtain nutritional benefit from its consumption. Moreover, the roasted flax seed can break up easily in a blender, making it possible and easy to produce smoothie-type drinks comprising flax seed that has been substantially processed into a fine particulate material by the blender. The roasted flax seed generated by the methods of the exemplary embodiments of the invention is also easy to chew when mixed with yoghurts, puddings or breakfast cereals etc.

The roasting processes encompassed by the methods of the exemplary embodiments, improve both the flavour characteristics of the flax seed and its capacity to be broken up more easily, making it much more adaptable for incorporation into a wide variety of different food products. The methods improve the characteristics of the flax seed when compared either to raw flax seed or flax seed roasted or otherwise processed by alternative methods. It is also important to note that raw flax seed has high mucilage content on the exterior making it prone to bacterial growth and development. The roasting processes encompassed by the methods of the present invention help to sterilize the flax seed killing most if not all bacteria present on the surface of the flax seed.

Exemplary embodiments of the invention will now be further described with further reference to the following examples, which are in no way intended to limit the scope of the invention as encompassed by the appended claims.

### EXAMPLES

### Example 1

### Analysis of Fatty Acid Content of Flax Seed Roasted in Accordance with the Methods of the Invention

Experiments were conducted to compare the nutritional content of raw, untreated flax seed with flax seed roasted in accordance with the methods of the present invention. For each experiment, samples of flax seed were processed substantially in accordance with the embodiment of the invention described with reference to FIG. 2. Each sample of flax seed was heated to a different temperature using a Jetzone fluidized bed apparatus, maintained for a predetermined time period, and rapidly cooled using a Jetzone fluidized bed apparatus. For each maintaining step, the samples of heated flax seed were maintained in an insulated roasting chamber without input of further thermal energy.

Following the roasting procedure, the samples of raw and roasted flax seed were analyzed by gas liquid chromatography according to a standard method prescribed by the Association of Analytical Communities (AOAC). Table 1 shows a comparison of the fatty acid content of each sample, including an analysis of the relative amounts of C12, C14, C16, and C18 fatty acids.

TABLE 1
Fatty acid analysis of flax seed, results indicate fatty acid (mg)/fat (g)

| | Brown | Golden | | | | | |
|---|---|---|---|---|---|---|---|
| | raw | raw | Golden roasted | | | | |
| Fatty acid | — | — | 146° C. | 163° C. | 166° C. | 163° C. | 166° C. |
| C12:0 | 0.42 | 0.25 | 0.19 | 0.23 | 0.15 | 0.21 | 0.15 |
| C14:0 | 0.93 | 1.27 | 0.68 | 0.97 | 0.59 | 0.72 | 0.91 |
| C16:0 | 61.4 | 48.5 | 50.9 | 51.5 | 51.1 | 51.6 | 52.2 |
| C16:1 | 1.43 | 1.92 | 1.25 | 1.22 | 1.03 | 0.96 | 1.12 |
| C18:0 | 33.2 | 42.5 | 37.4 | 39.3 | 38.1 | 38.3 | 38.8 |
| C18:1 | 166.2 | 180.5 | 185.0 | 188.0 | 184.8 | 184.3 | 183.6 |
| C18:2 | 152.8 | 138.1 | 152.6 | 145.9 | 145.9 | 144.6 | 146.3 |
| C18:3 | 559.0 | 555.0 | 555.0 | 567.2 | 572.9 | 570.7 | 568.9 |

The first two results columns in Table 1 indicate the fatty acid content of samples of brown and golden raw flax seed, whereas the remaining columns indicate the fatty acid content of samples of golden flax seed heated to various temperatures up to about 166° C. The results indicate that there are no significant differences between the fatty acid compositions (that could not be attributed to accepted analytical error) of the samples of raw flax seed and the samples that had undergone a roasting process in accordance with the exemplary methods of the present invention. The results confirm that the methods of the invention do not have tendency to destroy the nutritional content of the flax seed, at least with regard to fatty acid components.

### Example 2

### Analysis of Cyanide Glycoside Content of Flax Seed Roasted in Accordance with the Methods of the Invention

The cyanide glycoside concentration of raw flax seed was compared with the cyanide glycoside concentration of flax seed roasted in accordance with the methods of the present invention by way of a fluidized bed roasting process. The method used to assay for the cyanide glycoside concentration involved the Pyridine-Pyrazolone method, as described for example in Kobaisy et al. (1996) J. Agric. Food Chem. 44(10), 3178-3181, to measure linamarin mono-glyceride content. The test results showed that the cyanide glycoside content of raw flax seed was about 130 ppm, whereas the cyanide glycoside content for the flax seed roasted in accordance with the methods of the present invention was about 0.4 ppm. Therefore, the roasting process of the present invention appears to reduce the cyanide glycoside content of the flax seed by more than about 99%.

### Example 3

### Analysis of Golden Roasted Flax Seed Roasted in Accordance with the Methods of the Invention

Golden roasted flax seed roasted in accordance to an exemplary method was submitted to SunWest™ Food Laboratory Ltd. for analysis. An analysis report No. 030970 dated Nov. 28, 2003 was issued outlining the nutritional content of the roasted flax seed.

TABLE 2
Nutritional analysis report no. 030970 of golden roasted flax seed

| Analysis | Result |
|---|---|
| Moisture g/100 g | 0.48 |
| Protein g/100 g | 23.01 |
| Total fat g/100 g | 46.40 |
| Saturates g/100 g | 4.74 |
| Trans fat g/100 g | <0.05 |
| Polyunsaturates g/100 g | 32.30 |
| Omega-6 g/100 g | 6.64 |
| Omega-3 g/100 g | 25.66 |
| Monounsaturates g/100 g | 9.36 |
| Cholesterol mg/100 g | <5.0 |
| Carbohydrate g/100 g | 26.45 |
| Fibre g/100 g | 24.47 |
| Sugars g/100 g | 1.20 |
| Ash g/100 g | 3.66 |
| Calories per 100 g | 615.14 |
| Calories from fat per 100 g | 417.6 |
| Vitamin A RE/100 g | <12 |
| Vitamin A IU/100 g | 39.96 |
| Vitamin C mg/100 g | 5.02 |
| Calcium mg/100 g | 210 |
| Iron mg/100 g | 4.2 |
| Sodium mg/100 g | 20 |

The results indicate an excellent nutritional content for the flax seed including, but not limited to, a high ration of Omega-3 to Omega-6 fatty acids.

For the purposes of this specification, the term “about” should be understood to encompass a suitable and acceptable error associated with monitoring and/or measuring devices used in the field and further encompasses a suitable variation provided that utility of the embodiment is maintained.

While the invention has been described with reference to particular exemplary embodiments thereof, it will be apparent to those skilled in the art upon a reading and understanding of the foregoing that numerous methods for processing oil seed such as flax seed, other than the specific embodiments illustrated are attainable, which nonetheless lie within the spirit and scope of the present invention. It is intended to include all such methods, equivalents thereof, and products derived therefrom, within the scope of the appended claims.

1. A method for roasting oil seed, the method comprising the steps of:
(a) heating the oil seed to a temperature of from about 130° C. to about 205° C. in less than about two minutes to produce heated oil seed;
(b) maintaining the heated oil seed at a sufficient temperature and for a sufficient period to produce roasted oil seed; and
(c) cooling the roasted oil seed.

2. The method of claim 1, wherein step (a) comprises exposing the oil seed to a temperature of from about 130° C. to about 175° C. for a period of from about 20 to about 60 seconds.

3. The method of claim 1, wherein step (a) comprises exposing the oil seed to a temperature of about 170° C. for a period of about 40 seconds.

4. The method of claim 1, wherein at least one of steps a), b) or c) is conducted under fluidized bed conditions.

5. The method of claim 4, wherein step (a) is conducted using a fluidized bed apparatus to effect rapid heating, the apparatus comprising:
a non-perforated conveyor for retaining the oil seed;
a plurality of spaced-apart jet-tubes for directing air jets of heating air at a high velocity generally downwardly onto the conveyor, thereby causing the jets of heating air to reflect off the conveyor for lifting, tumbling, separating, and rapidly heating the oil seed.

6. The method of claim 5, wherein the apparatus is a Jetzone™ fluidized bed apparatus.

7. The method of claim 5, wherein the oil seed is heated from an ambient temperature to a temperature of from about 130° C. to about 205° C. in less than about 50 seconds.

8. The method of claim 7, wherein the oil seed is heated from an ambient temperature to a temperature of from about 130° C. to about 205° C. in less than about 40 seconds.

9. The method of claim 1, wherein in step (b) the temperature of the oil seed falls during the period.

10. The method of claim 9, wherein in step (b) the oil seed is maintained in an insulated or partially insulated roasting chamber or tower without the addition of external heat.

11. The method of claim 10, wherein step (b) continues for a duration predetermined according to a rate of heat discharge from the chamber.

12. The method of claim 1, wherein step (b) comprises maintaining the oil seed for a period of from about 2 to about 15 minutes.

13. The method of claim 3, wherein step (b) comprises maintaining the oil seed for a period of about 9 minutes.

14. The method of claim 1, wherein step (c) is conducted using a fluidized bed apparatus to effect rapid cooling, the apparatus comprising:
a non-perforated conveyor for retaining the oil seed;
a plurality of spaced-apart jet-tubes for directing jets of cooling air generally downwardly onto the conveyor, thereby causing the jets of cooling air to reflect off the conveyor for lifting, tumbling, separating, and rapidly cooling the oil seed.

15. The method of claim 14, wherein the apparatus is a Jetzone™ fluidized bed apparatus.

16. The method of claim 1, wherein step (c) is conducted using a cooling apparatus comprising:
a conveyor for retaining the oil seed;
means for drawing cooling air around the retained oil seed and through the perforated conveyor, thereby to rapidly cool the oil seed.

17. The method of claim 16, wherein the conveyor is a perforated conveyor.

18. The method of claim 16, wherein the cooling apparatus is a Through-Draft Belt Cooler™.

19. The method of to claim 1, wherein the oil seed is cooled from a temperature of from about 90° C. to about 205° C. to ambient temperature +/−10° C. in less than about 2 minutes.

20. The method of any one of claims 1 to 19, wherein the oil seed is a flax seed from the family Linaceae.

21. The method of claim 20, wherein the flax seed is L. usitatissimum.

22. Roasted oil seed generated by the method of to any one of claims 1 to 20.

23. Roasted flax seed generated by the method of claim 20 or 21.

24. A food product for human or animal consumption comprising the roasted oil seed of claim 22.

25. The food product of claim 24 wherein the oil seed is flax seed.

26. A beverage product for human or animal consumption comprising the roasted oil seed product of claim 22.

27. The beverage product of claim 26, wherein the oil seed is flax seed.
